(19) United States
(12) Patent Application Publication
(10) Pub. No.: US 2020/0061934 A1
(43) Pub. Date: Feb. 27, 2020

(54) FIBER PRECURSOR

(71) Applicant: AREVO, INC., Santa Clara, CA (US)

(72) Inventors: Natalie Margaretha Rudolph, Santa Clara, CA (US); Danning Zhang, Sunnyvale, CA (US)

(73) Assignee: AREVO, INC., Santa Clara, CA (US)

(21) Appl. No.: 16/113,036

(22) Filed: Aug. 27, 2018

(51) Int. Cl. B29C 70/16; B33Y 10/00; B33Y 70/00; D02G 3/02; D02G 3/36; D02G 3/44; B29C 64/165; D04C 1/02; B29C 70/38; D04C 1/06

(52) U.S. Cl. CPC B29C 70/16; B33Y 10/00; B33Y 70/00; D02G 3/02; D02G 3/36; B29K 2307/04; B29C 64/165; D04C 1/02; B29C 70/382; D04C 1/06; D10B 2101/12; D02G 3/44

(57) ABSTRACT

The present invention provides an improved fiber precursor, and methods for employing such to enhance the structural reinforcement of composite structures. The precursor is comprised of one or more fibrous filaments positioned within the precursor so that the filaments within each fiber are oriented at an angle offset from the axis of the length of the precursor. The offset of these filaments can be accomplished, for example, by twisting a plurality of filaments into a continuous spiral to form the precursor, or by wrapping a collection of colinear filaments about a central core, or by braiding plurality of filaments to form the precursor. The angle of offset at which the twisted, braided or wrapped fibers are positioned can be varied as a function of the twisting, braiding or wrapping process (angle of wrap, tension upon the twisting or wrapping fibers, degree of rotational twisting applied to the fibers per length of precursor, etc.). The offset angle can be arbitrarily chosen to achieve the desired shear properties based upon the particular composite structure, the manufacturing method(s) being employed, and the environment in which the precursor will be utilized.

### FIELD

The present invention relates generally to the fabrication of composite structures and components, and more specifically to a fiber precursor for such structures and components.

### BACKGROUND

There are numerous processes and technologies for fabrication of composite structures and components. These include 3-D printing technologies, autoclave curing, out-of-autoclave (“OOA”) curing, injection molding, liquid molding and hot pressing. Each of these technologies requires one or more fiber precursors to serve as the basis for the fabricated composite structure.

One technology for creating such precursors is tailored fiber placement (“TFP”). TFP was first developed in the 1990's, enabling the production of arbitrarily-shaped fiber precursors. TFP involves positioning and securing a bundle of fibers, referred to as a roving, upon a base substrate material, to form an integrated precursor for a fiber-reinforced composite structure. Typically, the strength and stiffness of such a fiber-reinforced structure is greatest along the direction in which the component fibers are aligned. The appropriate offset of the component fiber alignment within the precursor results in a structure exhibiting quasi-isotropic strength and stiffness along the plane of the composite structure. However, such structure will exhibit far less strength and stiffness with regard to forces applied orthogonally to the fiber placing plane.

FIG. 1 provides an illustration of the type of equipment typically utilized to perform TFP. As shown, roving 102 is positioned along the surface of substrate 104 (typically a fabric) by the roving pipe 106 of a TFP embroidering system. As roving 102 is fed through roving pipe 106, needle 108 of the TFP embroidery system secures roving 102 to substrate 104 by sewing it into position with upper thread 110. This sewing process is similar to that of a standard sewing machine in as much as it involves an upper thread 110 fed through needle 108, and a lower thread (not illustrated), fed in from a bobbin apparatus (not illustrated) located below the substrate. Typically, the roving is attached in a predetermined pattern, and resin is applied to bind the fibers of the roving to form a solid composite structure. The roving provides reinforcement of the resulting composite structure.

TFP has proven to be effective for fabricating complex, arbitrarily-shaped composite components, and for providing structural reinforcement of composite structures. The pattern of the roving upon the substrate can be calculated so as to optimize this reinforcement to compensate for localized or directed stresses that the resulting composite structure may be exposed to. Examples of particular methods for performing and optimizing roving placement for structural reinforcement are disclosed in Spickenheuer, A., et al. “Using tailored fibre placement technology for stress adapted design of composite structures,” Plastics and Rubber Composites, vol. 37, pp. 227-232 (March 2008) and Gliesche, K, et al., “Application of the tailored fibre place (TFP) process for a local reinforcement on an ‘open hole’ tension plate from carbon/epoxy laminates,” Comp. Sci. and Tech., vol. 63, pp. 81-88 (2003), which are incorporated by reference herein. The roving material itself is typically comprised of a grouping or bundle of colinear fiber filaments, running substantially parallel to the axis of the length of the roving. As stated previously, the strength and stiffness of a fiber-reinforced structure is greatest along the direction in which the fibers are aligned. Consequently, the maximum stiffness and greatest strength of such a fiber roving applied to a structure will be exhibited along the plane of that structure, not in a plane orthogonally situated to that of the structure. Present roving and roving processes are incapable of fully exploiting the physical and mechanical qualities of the fibers within the roving so as to maximize the orthogonal strengthening of a structure. The inability to take full advantage of these physical and mechanical properties within the roving itself is also presented in additive manufacturing processes such as fused filament fabrication; the fused filament does not possess the full strength and stiffness it might otherwise possess in the direction perpendicular to the printing direction.

### BRIEF SUMMARY OF THE INVENTION

Disclosed herein is an improved fiber precursor, and methods for employing such to enhance the structural reinforcement of composite structures. The precursor is comprised of one or more fibrous filaments positioned within the precursor so that the filaments within each fiber are oriented at an angle offset from the axis of the length of the precursor. The offset of these filaments can be accomplished, for example, by twisting a plurality of filaments into a continuous spiral to form the precursor, or by wrapping a collection of colinear filaments about a central core, or by braiding plurality of filaments to form the precursor. The angle of offset at which the twisted, braided or wrapped fibers are positioned can be varied as a function of the twisting, braiding or wrapping process (angle of wrap, tension upon the twisting or wrapping fibers, degree of rotational twisting applied to the fibers per length of precursor, etc.). The offset angle can be arbitrarily chosen to achieve the desired shear properties based upon the particular composite structure, the manufacturing method(s) being employed, and the environment in which the precursor will be utilized.

In one example the fiber precursor includes a plurality of fibers arranged to form a continuous cylindrical element, where the fibers are predominantly aligned to a fixed angle offset from a longitudinal axis of the cylindrical element. The fiber precursor includes comingled resin and reinforcement fibers. One example of resin fibers is thermoplastic fibers. One example of reinforcement fibers is carbon fibers. In one example the fiber precursor is formed by twisting the fibers about the longitudinal axis to form the continuous cylindrical element. The fiber precursor may include about 1,000 to about 50,000 fibers.

In one embodiment the fixed angle is offset from the longitudinal axis of the cylindrical element by 45 degrees.

Also described herein is an additive manufacturing process, including the steps of: heating the fiber precursor to a temperature at which the precursor becomes nominally plastic such that the fiber precursor will retain the shape imposed on it by the applied forces. The additive manufacturing process may also include depositing the heated fiber precursor upon a build surface in a controlled pattern. The heated fiber precursor may be deposited using a nozzle. In one embodiment, the additive manufacturing process includes depositing the heated fiber precursor in a controlled pattern to create a three-dimensional object. The heated fiber precursor may be cooled prior to being heated.

Also described herein is a fiber precursor including a straight core having a longitudinal axis that includes a first bundle of a plurality of colinear fibers and at least one additional bundle of a plurality colinear fibers wrapped around the straight core so as to form a coil about the straight core, where each section of the coil is offset from the longitudinal axis of the straight core by the same fixed angle (e.g. 45 degrees). In one embodiment, the first bundle and the at least one additional bundle have circular cross-sections. The cross-sectional diameter of the first bundle may be less than, substantially equal to or greater than the cross-sectional diameter of the at least one additional bundle. In another embodiment, the first bundle has a rectangular cross-section and the at least one additional bundle has a circular cross-section. In another embodiment, the first bundle has a rectangular cross-section and the at least one additional bundle includes a flexible tape. The first bundle and the at least one additional bundles may include comingled resin (e.g. thermoplastic fibers) and reinforcement fibers (e.g. carbon fibers). The fiber precursor of this embodiment is formed by wrapping the at least one additional bundle of fibers around the straight core of colinear fibers.

In other embodiments, the fiber precursor includes three or more bundles of a plurality of colinear fibers interlaced with each other to form an interlocking, repeating pattern. Examples of repeating patterns include flat braids, regular braids, three-dimensional braids, tubular braids. The number of fibers in a bundle is about 1000 fibers to about 50,000 fibers.

### DESCRIPTION OF THE DRAWINGS

The features, aspects, and advantages of the present invention will become better understood with regard to the following description, appended claims, and accompanying drawings in which:

FIG. 1 is a perspective view of equipment typically utilized to perform TFP.

FIG. 2 is a perspective view of an exemplary apparatus for twisting fibers to form an improved fiber precursor.

FIGS. 3A and 3B depict the process of wrapping a central fiber core with a fiber bundle having a substantially circular cross-section to form an improved fiber precursor.

FIGS. 4A and 4B depict an alternate process of wrapping a central fiber core with a fiber bundle having a substantially circular cross-section to form an improved fiber precursor.

FIGS. 5A, 5B and 5C depict the process of wrapping a central fiber core with a flexible tape to form an improved fiber precursor.

FIGS. 6A, 6B and 6C depict an alternate process of wrapping a central fiber core with a flexible tape to form an improved fiber precursor.

FIG. 7 depicts a section of an improved fiber precursor formed by braiding three bundles.

FIG. 8 is a cross-sectional view of an additive manufacturing manifold.

### DETAILED DESCRIPTION

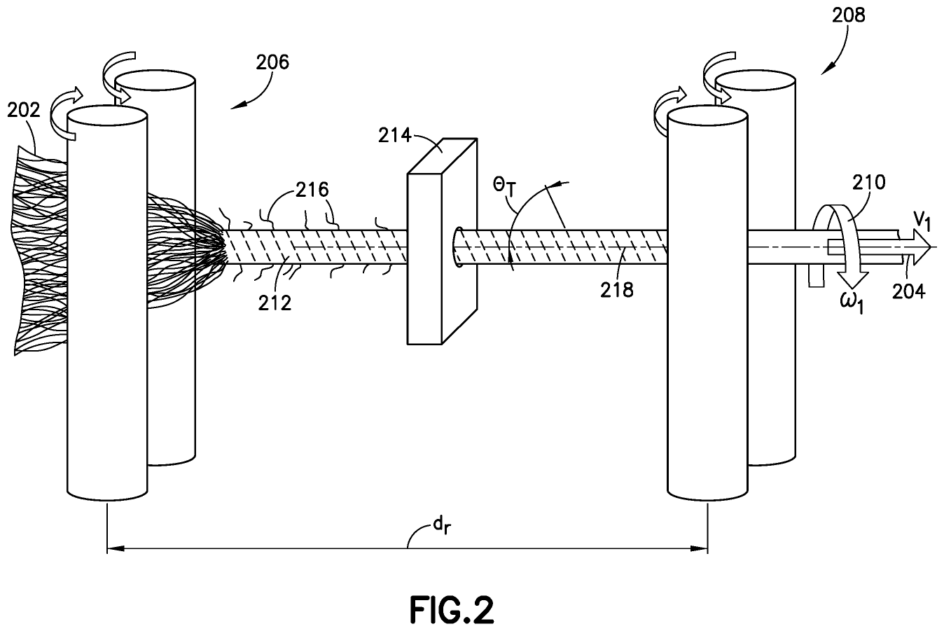

FIG. 2 is a perspective view of an exemplary apparatus adapted to mechanically twist comingled fibers to form a fiber precursor in accordance with a particular embodiment of the instant invention. As shown a collection of fibers 202, typically consisting of about 1000 to about 50,000 individual fibers are drawn forward at a continuous rate, V₁ (as indicated by arrow 204) through the action of roller sets 206 and 208. The fibers are twisted at a continuous rate (for this example, in a clockwise direction at a rate of θ₁ as indicated by arrow 210) as they are drawn forward so as to cause the collection of fibers to form twisted precursor 212. Twisted precursor 212 is then passed through die 214 which serves to trim any stray fibers 216 from the precursor. The rate at which the fibers are drawn forward (V₁) in combination with the rate at which the fibers are twisted (ω₁), and the distance between roller sets 206 and 208 determines the angle of offset (Θ_{T}) the twisted fibers assume with respect to the longitudinal axis 218 of precursor 212.

Increasing V₁ will reduce offset angle Θ_{T}, increasing twisting rate ω₁ will increase Θ_{T}, and reducing in the distance (dᵣ) between roller sets 206 and 208 decreases Θ_{T}. These variables can be altered depending upon the desired offset angle, the physical characteristics of the fibers being drawn, the desired density of the resulting precursor, as well as other considerations that might arise based upon the specific apparatus being employed to perform the formation of the precursor and the environmental conditions in which it is being formed.

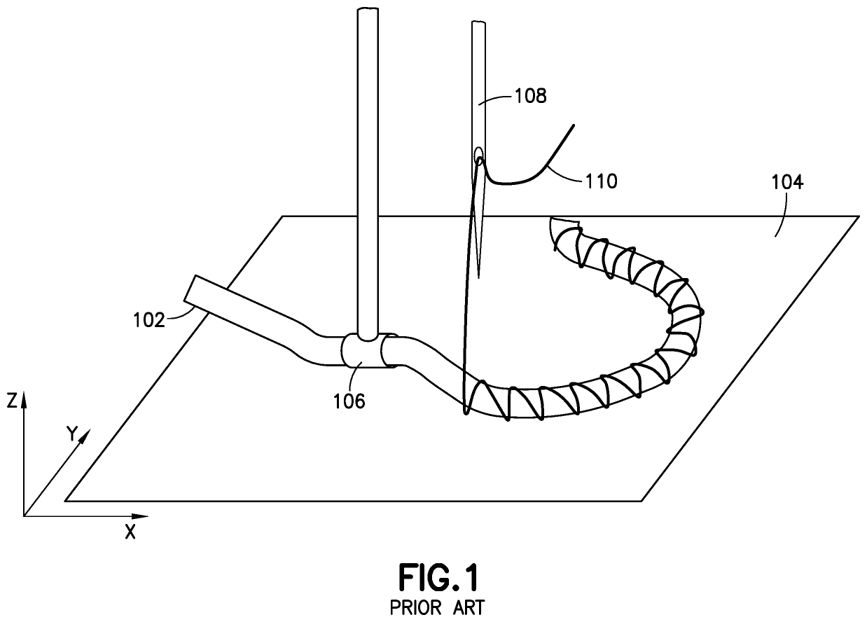

As stated above, the particular offset angle, Θ_{T}, can be varied by manipulating V₁, ω₁, and dᵣ. Although the offset angle is not restricted to any particular value, well-known and generally accepted design theory for fiber composites, such as those set forth in Chou, T., Microstructural Design of Fiber Composites, Thermoplastic behavior of laminated composites, pp. 39-46, FIG. 2.4 (Cambridge University Press 1992), which is incorporated by reference herein, prescribe that an offset angle of 45°, with respect to the plane of the substrate surface to which the precursor is affixed, would maximize the shear property of the resultant precursor/substrate structure. Note that the surface of the substrate would be aligned with the longitudinal axis of precursor affixed thereto in the manner illustrated in FIG. 1, and that this alignment results in the twisted fibers of precursor 212 being offset from the plane of the substrate surface by angle Θ_{T}. Consequently, a precursor comprised of twisted fibers having an offset angle Θ_{T} of 45° would be desirable for applications where the maximization of shear strength is the desired outcome.

Comingled fibers 202 utilized to form the twisted precursor are typically comprised of both reinforcing fibers and thermoplastic resin fibers. Reinforcing fibers include fibers comprised of materials such as carbon, glass, aramid, ultra-high molecular weight polyethylene (UHMPE), boron, steel, copper, and carbon nanotubes. Thermoplastic resin fibers include fibers comprised of materials such as nylon 66, nylon 6, nylon 12, polypropylene (“PP”), polyethylene (“PE”), polyester, polyether ether ketone (“PEEK”), polyphenylene sulfide (“PPS”), polyetherimide (“PEI”), and polyvinylidene difluoride (“PVDF”). The distribution of these two types of fibers within the twisted precursor is critical with respect to the resultant precursor/substrate structure, as this ratio determines the fiber/volume make-up of that structure. This ratio can be adjusted based upon the particular application and environment for which the precursor/laminate structure is being fabricated. However, regardless of the particular ratio, it is desirable to ensure that there is a uniform distribution of the thermoplastic resin fibers among the reinforcing fibers within the precursor. This uniform distribution provides for a precursor that exhibits predictable, consistent characteristics throughout the fabrication process of the structure, and consistent performance with respect to mechanical properties, such as shear strength, once incorporated into the structure.

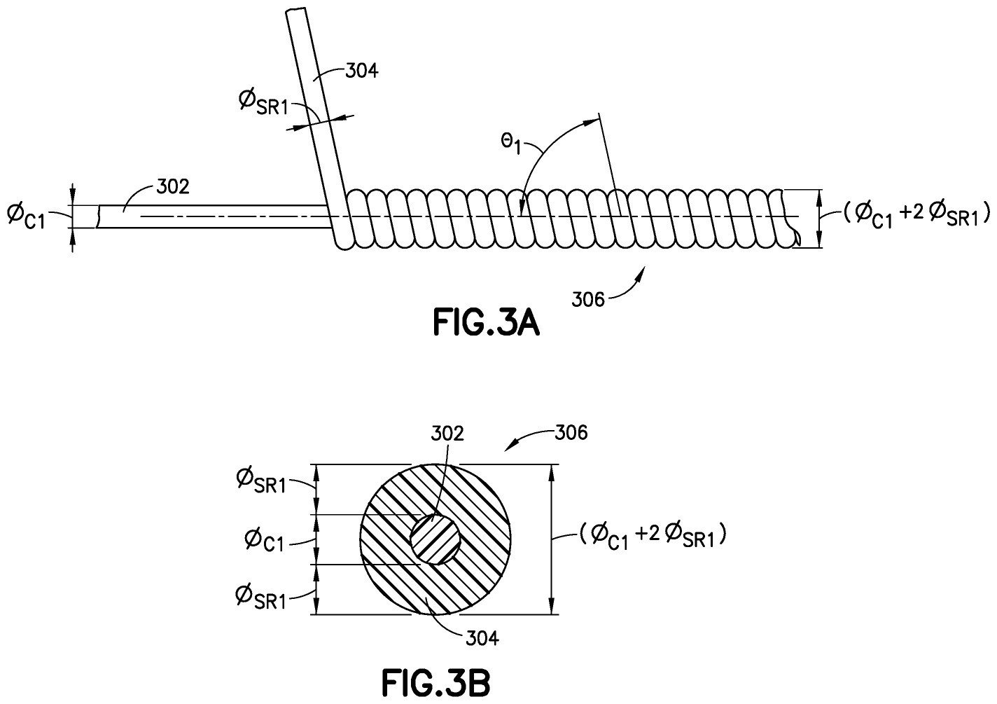

An additional embodiment of the invention is illustrated in FIG. 3A. As shown, a straight core 302, having a diameter of Ø_{C1}, is fabricated from a bundle of colinear fibers. Straight core 302 is then wrapped with colinear fiber bundle 304, which has a diameter of Ø_{SR1}, so as to form a coil about the straight core with the wrapped colinear bundle. The wrapping is performed at a fixed angle of Θ₁ with respect to the longitudinal axis of straight core 302, so that each section of the coil is offset from the longitudinal axis of the straight core by an angle of Θ₁. This results in the fabrication of a wrapped precursor 306 having an effective diameter of (Ø_{C1}+2Θ_{SR2}). Assuming wrapped precursor 306 is affixed to the surface of a substrate in a manner similar to that illustrated in FIG. 1, the angle, Θ₁, at which bundle 304 is wrapped around straight core 302 would be the angle at which the axes of the colinear fibers within bundle 304 would be offset from the plane of the substrate surface. FIG. 3B provides a cross-sectional view of wrapped precursor 306. As with the first embodiment of the invention, the fibers within straight core 302 and bundle 304 are comprised of comingled fibers (both reinforcing fibers and thermoplastic resin fibers). The distribution of these two types of fibers being chosen to suit the particular application and environment for which the precursor is being fabricated.

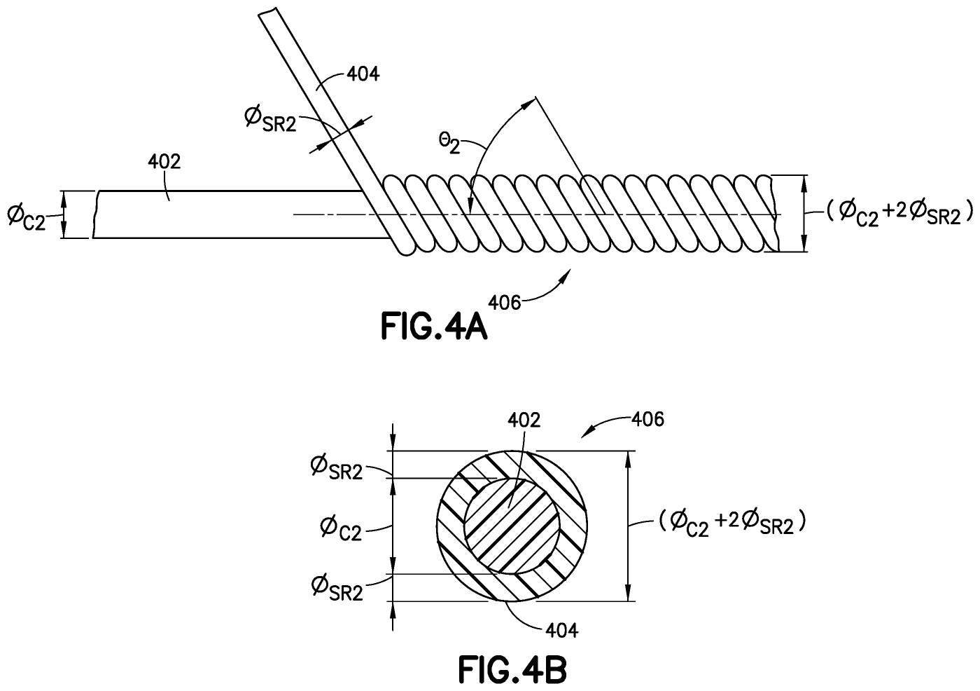

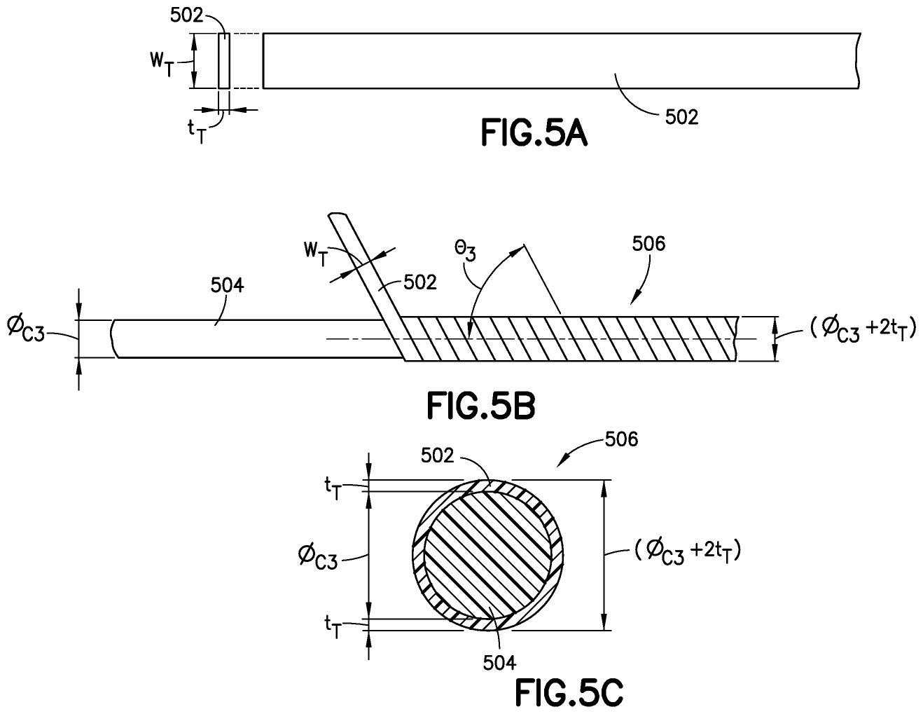

The diameters of the straight core and colinear fiber, as well as the wrapping angle can be varied as needed for particular applications. In FIG. 4A, straight core 402, comprised of comingled fibers, having a diameter of Θ_{C2} is wrapped at angle θ₂ with comingled colinear bundle 404, which has a diameter of Ø_{SR2}. As shown, Ø_{C2} is approximately three times Ø_{SR2}. The additional tensile strength imparted to a precursor/substrate structure by affixing wrapped precursor 406 thereto is directly proportional to the diameter of straight core 402. Similarly, the additional shear strength imparted to a precursor/substrate structure by affixing wrapped precursor 406 thereto is directly proportional to the diameter of wrapped bundle 404 and angle of the wrapping. FIG. 4B provides a cross-sectional view of wrapped precursor 406. Embodiments of this invention are not limited to precursors or fiber bundles having a substantially circular cross-section. For example, a flexible tape having a rectangular cross-section could be fabricated from a grouping of comingled, colinear fibers (typically about 1,000 to about 50,000 individual fibers). FIG. 5A provides a cross-sectional and top view of such a tape. Tape 502 has a width of w_{T} and a thickness of t_{T}. As shown in FIG. 5B, straight core 504, comprised of comingled fibers, having a diameter of Ø_{C3} is wrapped at angle θ₃ with tape 502 to form precursor structure 506. FIG. 5C provides a cross-sectional view of wrapped precursor 506.

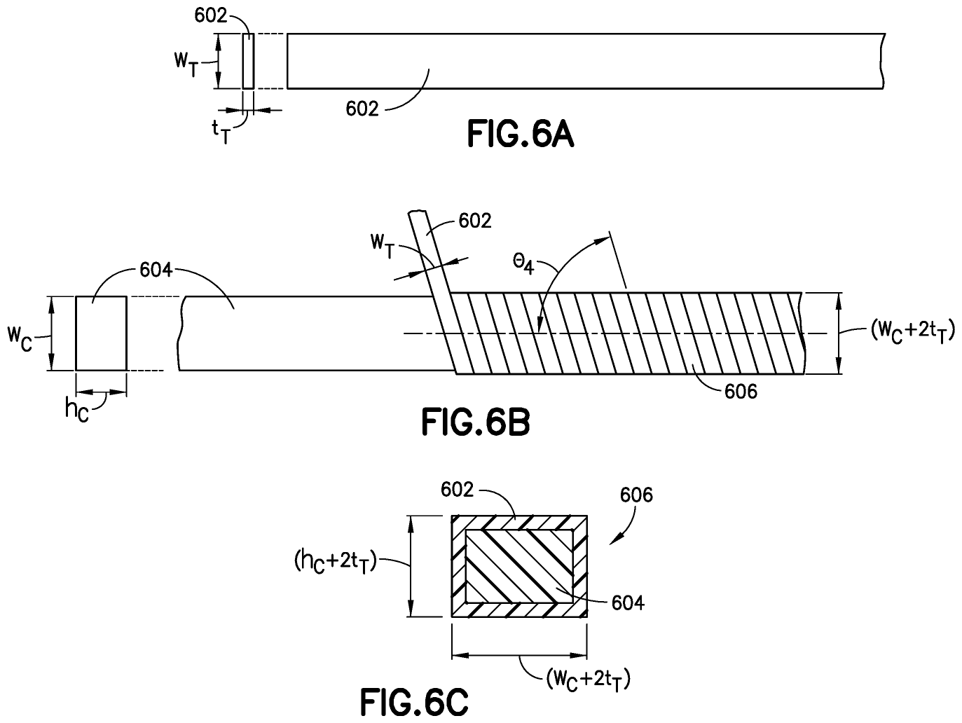

FIGS. 6A-C provide an illustration of yet another embodiment of the invention, similar to that depicted in FIGS. 5A-C. FIG. 6A shows flexible tape 602 (fabricated from a bundle of comingled, colinear fibers or through a slurry bath or melt extrusion impregnation) and having a width w_{T} and a thickness t_{T}. Tape 602 is wrapped around straight core 604 at angle θ₄ to form precursor 606. However, straight core 604 is shown in FIG. 6B to have a rectangular cross-section of width w_{C} and height h_{C}. Straight core 604 is fabricated from a bundle of comingled, colinear fibers that have been formed into rectangular solid, either by heating the bundle so as to melt all or some of the thermoplastic resin fibers within the comingled bundle that comprises straight core 604, or by the addition of a resin or other binder. As shown in FIG. 6C, precursor 606 has a rectangular cross-section with a height (h_{C}+2t_{T}) and a width of (w_{C}+2t_{T}).

It will be understood that although FIGS. 6A-C depict a straight core having a rectangular cross-section, other cross-sectional geometries could be utilized in further embodiments of the invention (triangular, oval, trapezoidal, etc.). Furthermore, the core need not be a straight core. Embodiments having curved cores, circular cores, or cores of other complex configurations are within the scope of the present invention. In addition, the wrapped core embodiments of FIGS. 3A-B, 4A-B, 5A-C and 6A-C are not limited to a single bundle or single layer being wrapped about a core. Multiple layers of identical, or dissimilar bundles can be wrapped about a core to suit the particular application and environment in which the precursor will be utilized.

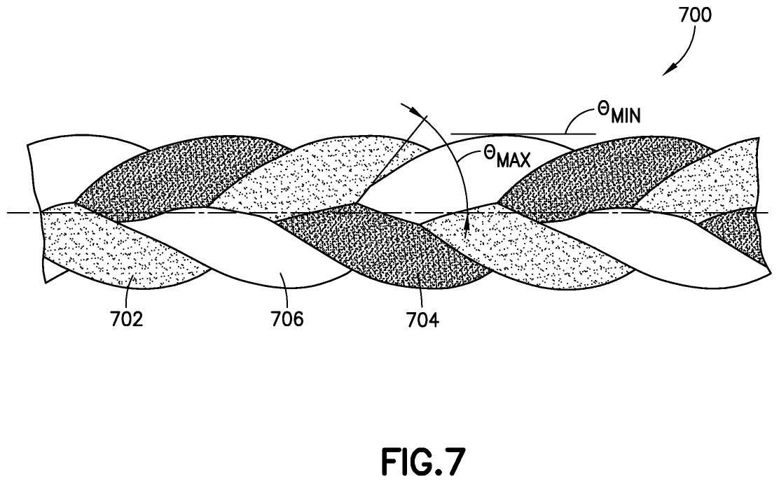

Yet another embodiment of the invention is depicted in FIG. 7. In this embodiment, a braided precursor (700) is formed from three bundles (702, 704 and 706) of colinear fibers (reinforcement fibers, or comingled bundles of reinforcement fibers and thermoplastic resin fibers) which are braided together. This braiding serves to vary the angle at which the direction of the colinear fibers within each bundle are offset from the longitudinal axis of the overall braided precursor. As shown, the offset angle varies from θ_{MAX} (which can approach 90° depending upon the braiding pattern) to θ_{MIN} (which is shown to be 0° for the embodiment illustrated in FIG. 7). This variation of the offset angle results in the braided precursor exhibiting both significant tensile strength (a function of the portions of braided bundles having an offset angle approaching 0°, and significant shear strength (a function of the portions of braided bundles having an offset angle approaching Θ_{MAX}). The braiding pattern shown in FIG. 7 is known as a “regular braid” and is considered a flat braid. Other, more complex flat braid patterns (such as the regular triaxial, diamond biaxial, diamond triaxial, and Hercules), as well as three-dimensional braid patterns (such as tubular or helical braiding) are well known in the textile art and could be utilized to create precursors in accordance with the instant invention.

Each of the embodiments of the precursor invention discussed above have been described as being primarily utilized in the fabrication of precursor structure. These structures typically require additional manufacturing processes, such as injection molding, autoclave curing, out-of-autoclave (“OOA”) curing, liquid molding and hot pressing, to be performed upon the precursor/substrate structures before a finished product or component is created.

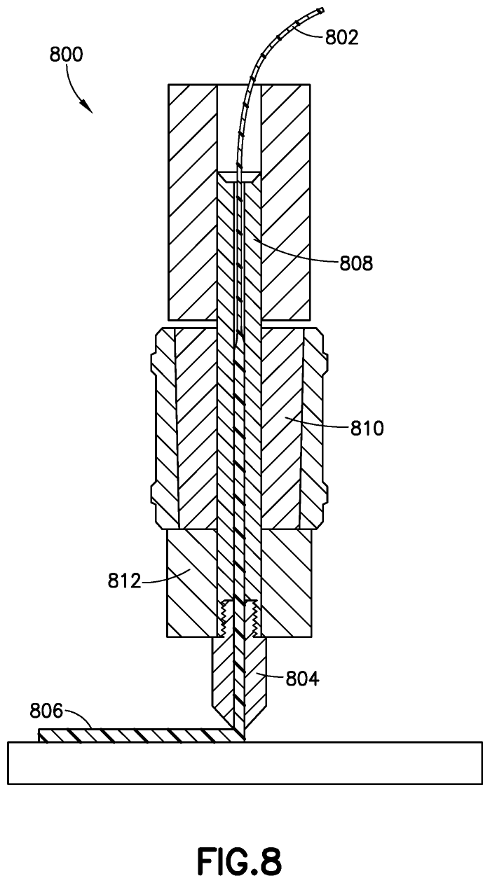

The precursors disclosed may also be employed in manufacturing processes not requiring the introduction of, or attachment to, a substrate. For example, the twisted precursor of FIG. 2 could be created using a ratio of thermoplastic resin fibers to reinforcing fibers that resulted in a precursor having physical properties suited for use in an additive manufacturing process, such as fused filament fabrication (“FFF”). An example of an FFF deposition manifold 800 is shown in FIG. 8.

In FFF, a precursor filament 802 is deposited from a deposition nozzle 804 onto build surface 806. A twisted precursor (such as the one illustrated in FIG. 2), a wrapped precursor (FIGS. 3B, 4B, 5B, 6B), or a braided precursor (FIG. 7), properly dimensioned to be fed through manifold 800 via filament tube 808, would pass through cooling block 810 and heating block 812. The cooling, and then successive heating of precursor filament 803 causes the precursor to undergo thermal and mechanical changes. The temperatures of the blocks 810 and 812 and the resin-to-reinforcement fiber ratio of precursor filament 802 are chosen so that precursor filament 802 is a plastic state as it is deposited upon the build surface. When in a plastic state, the precursor filament can be formed into a shape and will retain that shape. The plastic state for various materials is well known to one skilled in the art and not described in detail herein. Deposition proceeds in a controlled pattern on the build surface to construct a 3D object from successive layers of precursor filament.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A fiber precursor comprising:
a plurality of twisted fibers arranged to form a continuous cylindrical element, wherein the fibers are predominantly aligned to twist at a fixed angle offset from a longitudinal axis of the continuous cylindrical element.

2. The fiber precursor of claim 1, wherein the fibers comprise comingled resin fibers and reinforcement fibers.

3. The fiber precursor of claim 2 wherein the resin fibers comprise thermoplastic fibers.

4. The fiber precursor of claim 2 wherein the reinforcement fibers comprise carbon fibers.

5. The fiber precursor of claim 1, wherein the fibers are twisted about the longitudinal axis to form the continuous cylindrical element.

6. The fiber precursor of claim 1, wherein the fixed angle is offset from the longitudinal axis by 45 degrees.

7. The fiber precursor of claim 1, wherein the plurality of twisted fibers comprises about 1,000 to about 50,000 fibers.

8. A method for fabricating fiber precursor, comprising the step of:
twisting, about a central axis, a plurality of fibers so that the fibers become predominantly aligned to a fixed angle offset from the central axis and form a continuous cylindrical element having a longitudinal axis along the central axis.

9. The method of claim 8 wherein the fibers comprise comingled resin fibers and reinforcement fibers.

10. The method of claim 9 wherein the resin fibers comprise thermoplastic fibers.

11. The method of claim 9 wherein the reinforcement fibers comprise carbon fibers.

12. The method of claim 8 wherein the fixed angle of offset from the central axis is 45 degrees.

13. The method of claim 8 wherein the plurality of fibers comprises between 1,000 and 50,000 fibers.

14. A fiber precursor comprising:
a straight core having a longitudinal axis and being comprised of a first bundle of a plurality of colinear fibers; and
at least one additional bundle of a plurality colinear fibers wrapped around the straight core so as to form a coil about the straight core, wherein the coil comprises a plurality of sections wherein each section of the coil is offset from the longitudinal axis of the straight core by a fixed angle wherein the fixed angle for each section is the same fixed angle.

15. The fiber precursor of claim 14 wherein the first bundle and the at least one additional bundle have circular cross-sections having a cross-sectional diameter.

16. The fiber precursor of claim 15 wherein the cross-sectional diameter of the first bundle is substantially equal to the cross-sectional diameter of the at least one additional bundle.

17. The fiber precursor of claim 15 wherein the cross-sectional diameter of the first bundle is greater than the cross-sectional diameter of the at least one additional bundle.

18. The fiber precursor of claim 15 wherein the cross-sectional diameter of the at least one additional bundle is greater than the cross-sectional diameter of the first bundle.

19. The fiber precursor of claim 14 wherein the first bundle has a rectangular cross-section and the at least one additional bundle has a circular cross-section.

20. The fiber precursor of claim 14 wherein the first bundle has a rectangular cross-section and the at least one additional bundle comprises a flexible tape.

21. The fiber precursor of claim 14 wherein the first bundle and the at least one additional bundle comprise comingled resin fibers and reinforcement fibers.

22. The fiber precursor of claim 21 wherein the resin fibers comprise thermoplastic fibers.

23. The fiber precursor of claim 21 wherein the reinforcement fibers comprise carbon fibers.

24. The fiber precursor of claim 14 wherein the fixed angle is 45 degrees.

25. A method for fabricating a fiber precursor, comprising the step of:
wrapping at least one bundle comprised of a plurality colinear fibers around a straight core comprised of a bundle of colinear fibers having a longitudinal axis, so form at least one coil with the at least one bundle about the straight core wherein each section of the at least one coil is offset from the longitudinal axis of the straight core by a fixed angle wherein the fixed angle for each section is the same fixed angle.

26. The method of claim 25 wherein the at least one bundle wrapped about the straight core and the bundle comprising the straight core each have circular cross-sections each having a cross-sectional diameter.

27. The method of claim 26 wherein the at least one bundle wrapped about the straight core and the bundle comprising the straight core have a substantially equal cross-sectional diameters.

28. The method of claim 26 wherein the cross-sectional diameter of the at least one bundle wrapped about the straight core is greater than the cross-sectional diameter of the bundle comprising the straight core.

29. The method of claim 26 wherein the cross-sectional diameter of the bundle comprising the straight core is greater than the cross-sectional diameter of the at least one bundle wrapped about the straight core.

30. The method of claim 25 wherein the at least one bundle wrapped about the straight core has a rectangular cross-sectional and the bundle comprising the straight core has a circular cross-section.

31. The method of claim 25 wherein the at least one bundle wrapped about the straight core comprises a flexible tape and the bundle comprising the straight core has a rectangular cross-section.

32. The method of claim 25 wherein the at least one bundle wrapped about the straight core and the bundle comprising the straight core comprise comingled resin fibers and reinforcement fibers.

33. The method of claim 32 wherein the resin fibers comprise thermoplastic fibers.

34. The method of claim 32 wherein the reinforcement fibers comprise carbon fibers.

35. The method of claim 32 wherein the fixed angle is 45 degrees.

36. A fiber precursor comprising:
three or more bundles of a plurality colinear fibers interlaced with one another so as to form an interlocking, repeating pattern.

37. The fiber precursor of claim 36, wherein the plurality of colinear fibers comprises comingled resin fibers and reinforcement fibers.

38. The fiber precursor of claim 37 wherein the resin fibers comprise thermoplastic fibers.

39. The fiber precursor of claim 38 wherein the reinforcement fibers comprise carbon fibers.

40. The fiber precursor of claim 37, wherein the interlocking, repeating pattern is a flat braid.

41. The fiber precursor of claim 40, wherein the flat braid is a regular braid.

42. The fiber precursor of claim 36, wherein the interlocking, repeating pattern is a three-dimensional braid.

43. The fiber precursor of claim 42, wherein the three-dimensional braid is a tubular braid.

44. The fiber precursor of claim 36, wherein the plurality of colinear fibers comprises about 1,000 to about 50,000 fibers.

45. A method for fabricating a fiber precursor, comprising the step of:
interlacing three or more bundles of a plurality colinear fibers so as to form a repeating pattern.

46. The method of claim 45 wherein the plurality of colinear fibers comprise comingled resin fibers and reinforcement fibers.

47. The method of claim 46 wherein the resin fibers comprise thermoplastic fibers.

48. The method of claim 46 wherein the reinforcement fibers comprise carbon fibers.

49. The method of claim 45 wherein the repeating pattern is a flat braid.

50. The method of claim 49 wherein the flat braid is a regular braid.

51. The method of claim 45 wherein the repeating pattern is a three-dimensional braid.

52. The method of claim 51 wherein the three-dimensional braid is a tubular braid.

53. The method of claim 45 wherein the plurality of colinear fibers comprises about 1,000 to about 50,000 fibers.

54. An additive manufacturing process, comprising the steps of:
heating a fiber precursor selected from the group consisting of a plurality of fibers arranged to form a continuous cylindrical element, wherein the fibers are predominantly aligned to a fixed angle offset from a longitudinal axis of the continuous cylindrical element;
a straight core having a longitudinal axis and being comprised of a first bundle of a plurality of colinear fibers and at least one additional bundle of a plurality colinear fibers wrapped around the straight core so as to form a coil about the straight core, wherein each section of the coil is offset from the longitudinal axis of the straight core by a fixed angle wherein the fixed angle for each section is the same fixed angle, and three or more bundles of a plurality of colinear fibers interlaced with one another so as to form an interlocking, repeating pattern to a temperature at which the fiber precursor becomes nominally plastic; and
depositing the heated fiber precursor upon a build surface in a controlled pattern.

55. The additive manufacturing process of claim 54 wherein the depositing of the heated fiber precursor in the controlled pattern creates a three-dimensional object.

56. The additive manufacturing process of claim 54 wherein the heated fiber precursor is cooled prior to being heated.

57. The additive manufacturing process of claim 54 wherein the heated fiber precursor is deposited via a nozzle.
